(19) United States
(12) Patent Application Publication
(10) Pub. No.: US 2013/0072261 A1
(43) Pub. Date: Mar. 21, 2013

(54) ELECTRONIC DEVICE AND METHOD FOR ADDING NEW OPERATING INTERFACE

(71) Applicant: QIANG YOU, Shenzhen City (CN)

(72) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/489,610

(22) Filed: Jun. 6, 2012

(30) Foreign Application Priority Data
Sep. 21, 2011 (CN) 201110281685.8

(51) Int. Cl. G06F 3/041

(52) U.S. Cl. 455/566

(57) ABSTRACT

An electronic device includes a display unit, a touch pad, and a processing unit. The display unit is capable of displaying a plurality of operating interfaces. The touch pad includes a touch detecting unit. The touch detecting unit detects a first slide operation on a current operating interface in the plurality of operating interfaces, and generates a first touch control signal. The processing unit adds a new operating interface to be displayed by the display unit in response to the first touch control signal.

### BACKGROUND

1. Technical Field

The disclosed embodiments relate to an electronic device and a method for adding a new operating interface.

2. Description of Related Art

Electronic devices, such as capacitance mobile phones, are capable of displaying a plurality of operating interfaces. The capacitance mobile phone includes a touch screen, when a user performs a slide operation on a current operating interface displayed by the touch screen, the touch screen displays one of the plurality of operating interfaces adjacent to the current operating interface.

However, a total number of the plurality of operating interfaces is limited. Commonly, the capacitance mobile phone only includes two or three operating interfaces, which cannot meet the user's need.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the two views.

FIG. 1 is a block diagram of an electronic device in accordance with an embodiment.

FIG. 2 is a flow chart illustrating a method for adding a new operating interface in accordance with an embodiment.

### DETAILED DESCRIPTION

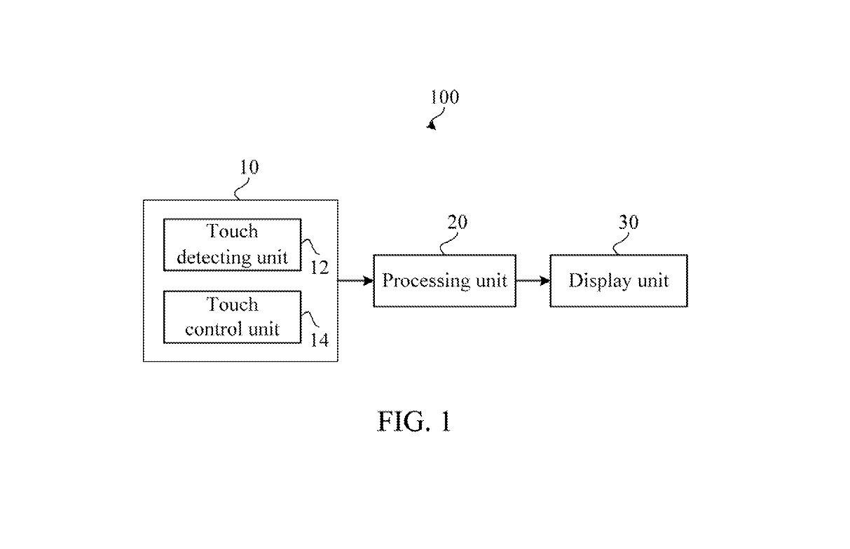

Referring to FIG. 1, an electronic device 100 includes a touch pad 10, a processing unit 20, and a display unit 30. The touch pad 10 includes a touch detecting unit 12 and a touch control unit 14. The display unit 30 is used for displaying a current operating interface in a plurality of operating interfaces, and is capable of displaying the plurality of operating interfaces. In this embodiment, the electronic device 100 is a capacitance mobile phone.

The touch detecting unit 12 is used for detecting whether a first slide operation is performed on the current operating interface, and generating a first touch control signal when the first slide operation is performed on the current operating interface. The touch detecting unit 12 is further used for detecting whether a second slide operation is performed on the current operating interface, and generating a second touch control signal when the second slide operation is performed on the current operating interface.

The touch control unit 14 is used for detecting a speed of the slide operation on the current operating interface, if the speed of the slide operation is slower than a predetermined speed, the touch control unit 14 ascertains that the first slide operation is performed. If the speed of the slide operation is faster than or equal to the predetermined speed, the touch control unit 14 ascertains that the second slide operation is performed. In other embodiments, if the speed of the slide operation is faster than or equal to a predetermined speed, the touch control unit 14 ascertains that the first slide operation is performed; if the speed of the slide operation is slower than the predetermined speed, the touch control unit 14 ascertains that the second slide operation is performed.

The processing unit 20 is used for adding a new operating interface into the plurality of operating interfaces in response to the first touch control signal. In detail, the new operating interface is arranged between the current operating interface and one of the plurality of operating interfaces adjacent to the current operating interface. Alternatively, the new operating interface is arranged between two adjacent operating interfaces in the plurality of operating interfaces selected by the user.

The processing unit 20 is further used for controlling the display unit 30 to display one of the plurality of operating interfaces adjacent to the current operating interface in response to the second touch control signal.

The first slide operation is performed within a predetermined region of the current operating interface, the area of the predetermined region is smaller than that of a whole region of the current operating interface. For example, the predetermined region is a middle region of the current operating interface. The purpose of the first slide operation being performed within a predetermined region of the current operating interface is for avoiding an operation error.

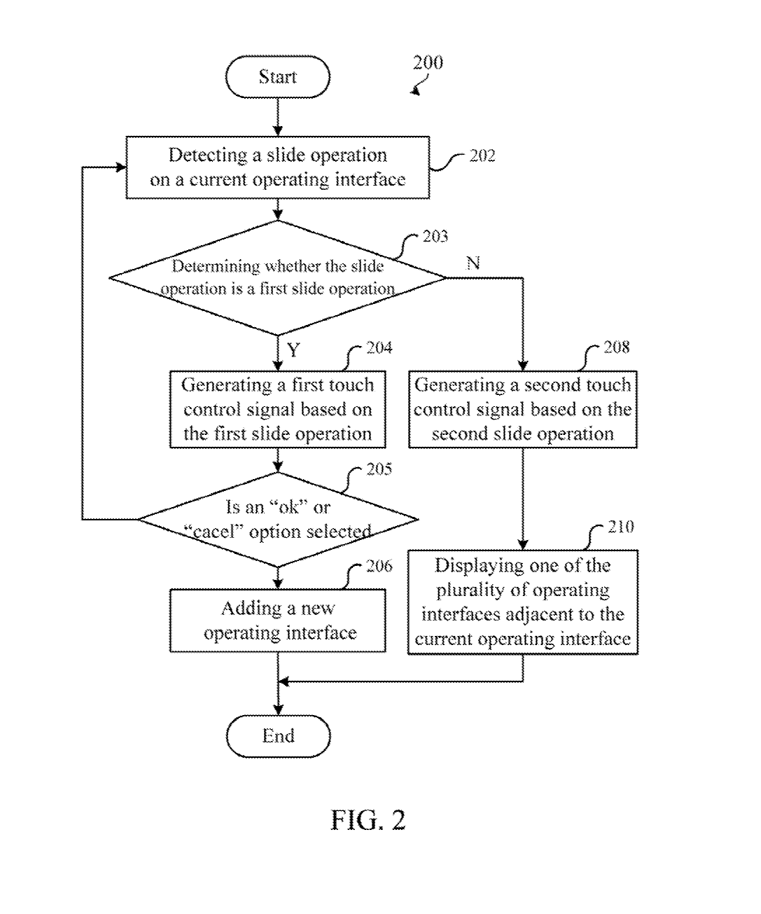

Referring to FIG. 2, a method 200 for adding a new operating interface is illustrated. The electronic device 100 performs the method 200, the method 200 includes the following steps:

Step 202, the touch detecting unit 12 detects a slide operation performed on the current operating interface.

Step 203, the touch control unit 14 determines whether the slide operation is a first slide operation. If the slide operation is the first slide operation, the procedure goes to step 204. If the slide operation is the second slide operation, the procedure goes to step 208. The touch control unit 14 calculates a speed of the slide operation and determines the first slide operation and the second slide operation by the speed of the slide operation. In detail, if the speed of the slide operation is slower than the predetermined speed, the touch control unit 14 ascertains that the first slide operation is performed. If the speed of the slide operation is faster than or equal to the predetermined speed, the touch control unit 14 ascertains that the second slide operation is performed.

Step 204, the touch detecting unit 12 generates a first touch control signal based on the first slide operation.

Step 205, the processing unit 20 controls the display unit 30 to display a dialog box including an “ok” option and a “cancel” option in response to the first touch control signal, and determines whether the “ok” option and the “cancel” option is selected. In this embodiment, the dialog box is displayed in the current operating interface. If the “ok” option is selected, the procedure goes to step 206. If the “cancel” option is selected, the processing unit 20 controls the display unit 30 to display the current operating interface and the procedure goes to step 202. In other embodiments, the dialog box includes a plurality of options, the total number of the plurality of options is larger than two, and the plurality of options includes the “ok” option and the “cancel” option.

Step 206, the processing unit 20 adds a new operating interface into the plurality of operating interfaces. In detail, the new operating interface is arranged between the current operating interface and one of the plurality of operating interfaces adjacent to the current operating interface. Alternatively, the new operating interface is arranged between two adjacent operating interfaces in the plurality of operating interfaces selected by the user. In other embodiments, the processing unit 20 directly adds the new operating interface in response to the first touch control signal.

Step 208, the processing unit 20 generates a second touch control signal based on the second slide operation.

Step 210, the processing unit 20 controls the display unit 30 to display one of the plurality of operating interfaces adjacent to the current operating interface in response to the second touch control signal.

Since the user performs the first slide operation on the current operating interface displayed by the display unit 30, the processing unit 20 adds the new operating interface into the plurality of operating interfaces, it can effectively meet the user's need.

Alternative embodiments will become apparent to those skilled in the art without departing from the spirit and scope of what is claimed. Accordingly, the present disclosure should not be deemed to be limited to the above detailed description, but rather only by the claims that follow and the equivalents thereof.

What is claimed is:

1. An electronic device, comprising:
a display unit for displaying a current operating interface in a plurality of operating interfaces, the display unit capable of displaying the plurality of operating interfaces;
a touch pad comprising a touch detecting unit for detecting whether a first slide operation is performed on the current operating interface, and generating a first touch control signal when the first slide operation is performed on the current operating interface; and
a processing unit for adding a new operating interface into the plurality of operating interfaces in response to the first touch control signal.

2. The electronic device of claim 1, wherein the first slide operation is performed within a predetermined region of the current operating interface, the area of the predetermined region is smaller than the area of a whole region of the current operating interface.

3. The electronic device of claim 1, wherein the new operating interface is arranged between the current operating interface and one of the plurality of operating interfaces adjacent to the current operating interface.

4. The electronic device of claim 1, wherein the new operating interface is arranged between two adjacent operating interfaces in the plurality of operating interfaces selected by the user.

5. The electronic device of claim 1, wherein the touch detecting unit is further used for detecting whether a second slide operation is performed on the current operating interface and generating a second touch control signal when the second slide operation is performed on the current operating interface; the processing unit is further used for controlling the display unit to display one of the plurality of operating interfaces adjacent to the current operating interface in response to the second touch control signal.

6. The electronic device of claim 5, wherein the touch pad further comprises a touch control unit for calculating a speed of the slide operation on the current operating interface, the first slide operation and the second slide operation are determined by the speed of the slide operation.

7. The electronic device of claim 6, wherein when the speed of the slide operation is faster than or equal to a predetermined speed, the touch control unit ascertains that the first slide operation is performed; when the speed of the second slide operation is slower than the predetermined speed, the touch control unit ascertains that the second slide operation is performed.

8. The electronic device of claim 6, wherein when the speed of the slide operation is slower than a predetermined speed, the touch control unit ascertains that the first slide operation is performed; when the speed of the second slide operation is faster than or equal to the predetermined speed, the touch control unit ascertains that the second slide operation is performed.

9. A method for adding a new operating interface, the method comprising the steps of:
providing a display unit for displaying a current operating interface in a plurality of operating interfaces, wherein the display unit is capable of displaying the plurality of operating interfaces;
detecting whether a first slide operation is performed on the current operating interface, and generating a first touch control signal when the first slide operation is performed on the current operating interface; and
adding a new operating interface into the plurality of operating interfaces in response to the first touch control signal.

10. The method of claim 9, wherein the first slide operation is performed within a predetermined region of the current operating interface, the area of the predetermined region is smaller than the area of a whole region of the current operating interface.

11. The method of claim 9, wherein the new operating interface is arranged between the current operating interface and one of the plurality of operating interfaces adjacent to the current operating interface.

12. The method of claim 9, wherein the new operating interface is arranged between two adjacent operating interfaces in the plurality of operating interfaces selected by the user.

13. The method of claim 9, further comprising the steps of:
detecting whether a second slide operation is performed on the current operating interface and generating a second touch control signal when the second slide operation is performed on the current operating interface; and
controlling the display unit to display one of the plurality of operating interfaces adjacent to the current operating interface in response to the second touch control signal.

14. The method of claim 13, further comprising:
calculating a speed of the slide operation on the current operating interface;
determining the first slide operation and the second slide operation by the speed of the slide operation.

15. The method of claim 14, wherein when the speed of the slide operation is faster than or equal to a predetermined speed, the first slide operation is determined; when the speed of the second slide operation is slower than the predetermined speed, the second slide operation is determined.

16. The method of claim 14, wherein when the speed of the slide operation is slower than a predetermined speed, the first slide operation is determined; when the speed of the second slide operation is faster than or equal to the predetermined speed, the second slide operation is determined.

17. An electronic device, comprising:
a display unit for displaying a current operating interface in a plurality of operating interfaces, the display unit capable of displaying the plurality of operating interfaces;
a touch pad comprising a touch detecting unit for detecting whether a first slide operation is performed on the current operating interface, and generating a first touch control signal when the first slide operation is performed on the current operating interface; and
a processing unit for controlling the display unit to display a dialog box comprising at least two options in response to the first touch control signal;
wherein the at least two options comprises an “ok” option and a “cancel” option, the processing unit adds a new operating interface into the plurality of operating interfaces when the “ok” option is selected by the user, and controls the display unit to display the current operating interface when the “cancel” option is selected by the user.

18. The electronic device of claim 17, wherein the dialog box is displayed in the current operating interface.
